(19) United States
(12) Patent Application Publication
(10) Pub. No.: US 2007/0195804 A1
(43) Pub. Date: Aug. 23, 2007

(54) PPP GATEWAY APPARATUS FOR CONNECTING PPP CLIENTS TO L2SW

(76) Inventors: Kengo Ijima, Yokohama (JP); Hisao Taguchi, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/560,171

(22) Filed: Nov. 15, 2006

(30) Foreign Application Priority Data
Feb. 17, 2006 (JP) 2006-040674

(51) Int. Cl. H04L 12/56; H04L 12/28

(52) U.S. Cl. 370/401; 370/420

(57) ABSTRACT

In a PPP gateway apparatus comprising a plurality of line interfaces each accommodating one of access lines for connecting to client terminals and core lines for connecting to layer 2 frame forwarding apparatuses, a frame forwarding control table, and a frame processor for controlling frame forwarding, the frame forwarding control table includes table entries each indicating the correspondence of a PPP session number to a client MAC address and frame definition information for the core line, and the frame processor operates, based on the frame forwarding control table, to forward a PPP frame received from one of access lines to one of core lines after converting it into a layer 2 Ethernet frame and to forward a frame received from one of the core lines and destined for a particular client MAC address to one of access lines after converting it into a PPP frame.

### CLAIM OF PRIORITY

The present application claims priority from Japanese application serial No. 2006-040674, filed on Feb. 17, 2006, the content of which is hereby incorporated by reference into this application.

### BACKGROUND OF THE INVENTION

(1) Field of the Invention

The present invention relates to a PPP gateway apparatus and, more specifically, to a PPP gateway apparatus for connecting through PPP links a plurality of client terminals to an access network where frames are forwarded by a protocol for layer 2 of the OSI reference model.

(2) Description of Related Art

RFC 1661 and RFC 1332 define a procedure for establishing a PPP (Point to Point Protocol) link between communication nodes and a procedure for establishing various layer 3 links over a PPP link and carrying out bidirectional communication. RFC 1334 defines a protocol for authenticating a network apparatus to be a connection peer during a PPP link connection process.

RFC 2516 prescribes a protocol called PPP over Ethernet (PPPoE) for setting up multiple PPP sessions over Ethernet. In the PPPoE, the links multiplexed on a same communication line are identified by session numbers. A network device that accommodates PPP links formed on an Ethernet or ATM network and connects these links to the Internet is generally called a Broadband Access Server (BAS).

During the PPP link connection process, a communication node can authenticate a client terminal in cooperation with an authentication server such as, for example, Remote Authentication Dial In User Service (RADIUS) server prescribed in RFC 2856 and a TACACS server prescribed in RFC 1492. The RADIUS server is equipped with a user authorization function and a charging function besides the user authentication function and this server has been used together with PPP since when a dial-up method was adopted to connect a user terminal to the Internet. As a method of assigning an IP address to a user terminal, Dynamic Host Configuration Protocol (DHCP) prescribed in RFC 2131 is known.

In Ethernet, a layer 2 frame forwarding apparatus (L2SW) is used to forward a received frame in accordance with its MAC address, instead of a router that routes a received packet in accordance with its IP address. A network architecture using a combination of Ethernet and L2SW draws attention for an ISP network that provides a connection service between a user terminal and the Internet, because the L2SW can be constructed with relatively simple logics and at lower cost.

In such a case where PPP client terminals having a connection control function at a layer 2 level are used as user terminals, a communication node (PPP gateway apparatus) that accommodates these user terminals generally terminates the PPP protocol and communicates packets with the Internet according to a layer 3 (IP). However, ISP networks of a layer 2 connection type using the combination of Ethernet and L2SW have been increasing in recent years.

### SUMMARY OF THE INVENTION

In an ISP network of the layer 2 connection type that includes L2SWs, as connecting a user terminal to the ISP network through a PPP link is difficult because of the following reasons, simple Ethernet link connection is usually adopted. For example, instead of decapsulated IP packet routing, a new technique for forwarding a layer 2 frame based on a predetermined policy is required in order to connect a PPP client terminal or PPP link to an L2SW via the PPP gateway apparatus at the time of processing a frame (PPP frame including an IP packet) received from the client. Further, a technique for selecting an appropriate PPP link in accordance with the destination IP address and for converting a received IP packet into a PPP frame is required at the time of processing a frame (Ethernet frame including the IP packet) received from the Internet side.

An object of the present invention is to provide a PPP gateway apparatus capable of connecting a plurality of PPP client terminals to a layer 2 frame forwarding apparatus (L2SW).

To achieve the above object, a PPP gateway apparatus of the present invention comprises a plurality of line interfaces each accommodating one of access lines for connecting to client terminals or core lines for connecting to layer 2 frame forwarding apparatuses; a frame forwarding control table comprising a plurality of table entries each indicating the correspondence of a PPP session number to a client MAC address and frame definition information for one of the core lines; and a frame processor for controlling communication frame forwarding between each of client terminals and the layer 2 frame forwarding apparatuses. The frame processor operates, based on the frame forwarding control table, to forward a PPP frame received from each of the access lines to one of the core lines after converting it into a layer 2 Ethernet frame and to forward a frame received from one of the core lines and destined for a particular client MAC address to one of the access lines after converting it into a PPP frame.

Here, if the access lines are Ethernet, the PPP frame comprises an Ethernet header, a PPPoE header, a PPP header, and an IP packet and the layer 2 Ethernet frame comprises an Ethernet header and an IP packet.

More specifically, in the PPP gateway apparatus of the present invention, each entry of the frame forwarding control table includes an access line interface number; and the frame processor operates, when processing a frame received from one of the core lines, to search the frame forwarding control table for a table entry including a client MAC address matched with the destination MAC address of the received frame, convert the received frame into a PPP frame in accordance with the session number indicated in the table entry, and transmit the PPP frame through one of said line interfaces specified by the access line interface number indicated in the table entry.

Further, in the PPP gateway apparatus of the present invention, each table entry of the frame forwarding control table includes a core line interface number and a MAC address of one of the frame forwarding apparatuses as the frame definition information for the core line; and the frame processor operates, when processing a frame received from one of the access lines, to search the frame forwarding control table for a table entry including a session number matched with a PPP session number extracted from the received frame, convert the received frame into a layer 2 Ethernet frame destined for the frame forwarding apparatus MAC address indicated in the searched table entry, and transmit the Ethernet frame through one of the line interfaces specified by the core line interface number indicated in the searched table entry.

In an embodiment of the present invention, the core line interface number is comprised of a physical link number and a logical link number; and the frame processor transmits, as the layer 2 Ethernet frame, a frame including the logical link number as identification information to one of the core lines specified by the physical link number.

In an embodiment of the present invention, the PPP gateway apparatus further includes a session control unit for executing a communication procedure for PPPoE and PPP between the gateway and each of the client terminals, and the session control unit specifies a MAC address of the client terminal and a PPP session number during the execution of a PPPoE connection procedure, specifies the frame definition information for one of the core lines during the execution of a client authentication procedure which is performed after PPP link establishment, and adds a new table entry corresponding to the specified PPP session number to the frame forwarding control table.

In an embodiment of the present invention, the PPP gateway apparatus further includes a domain information table comprising a plurality of table entries each defining the correspondence of a domain name to a core line interface number and the MAC address of one of the frame forwarding apparatuses, and the session control unit specifies the core line interface number and the MAC address of the frame forwarding apparatus by referring to the domain information table based on the domain name, which is notified from an authentication server and to which the client terminal belongs, during the execution of the client authentication procedure, and adds a new entry including the core line interface number and the MAC address of the frame forwarding apparatus as the frame definition information for the core line to the frame forwarding control table.

According to the gateway apparatus of the present invention, it is made possible to connect a user terminal provided with a PPP client function to a layer 2 network comprised of Ethernet. Further, by learning the MAC address of the client terminal when a PPP link is established and storing the MAC address as long as the PPP link continues to exist, it is made possible to determine the forwarding destination of a frame received from the core line without carrying out flooding.

### BRIEF DESCRIPTION OF THE DRAWINGS

FIG. 1 shows an overview of a network to which a PPP gateway apparatus 10 according to the present invention is applied.

FIG. 2 shows protocol stacks for communication between a client terminal 20 and a server 60 on the Internet NW.

FIG. 3 illustrates a sequence for connection between a client terminal 20 and the Internet NW.

FIG. 4 shows an example of a hardware configuration of the PPP gateway apparatus 10 according to the present invention.

FIG. 5 shows an example of a software configuration of the PPP gateway apparatus 10.

FIG. 6 illustrates a PPP user management table 250 provided in the PPP gateway apparatus 10.

FIG. 7 illustrates a domain information table 260 provided in the PPP gateway apparatus 10.

FIG. 8 illustrates a frame forwarding control table 270 provided in the PPP gateway apparatus 10.

FIG. 9 is a flowchart for establishing a link, to be performed by the PPP gateway apparatus 10.

FIG. 10 is a flowchart of frame processing to be performed by the PPP gateway apparatus 10.

FIGS. 11A and 11B illustrate conversion from a PPP frame into an Ethernet frame.

FIGS. 12A and 12B illustrate conversion from an Ethernet frame into a PPP frame.

### DETAILED DESCRIPTION OF PREFERRED EMBODIMENTS

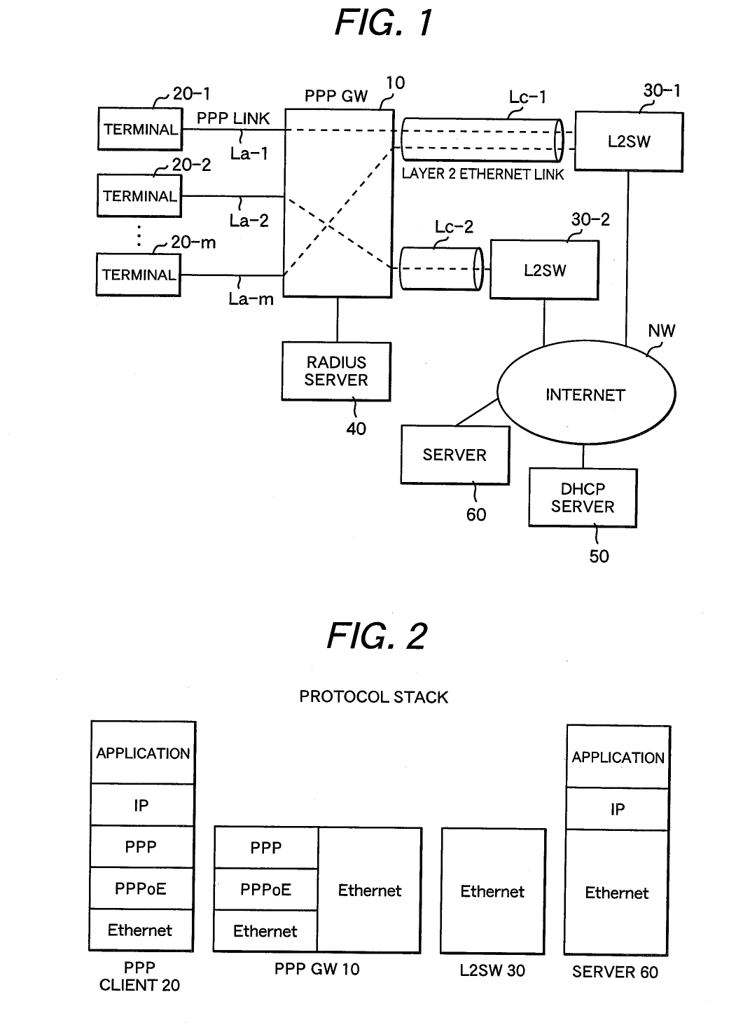

FIG. 1 shows an overview of a network to which a PPP gateway apparatus of the present invention is applied.

The PPP gateway apparatus (PPP GW) 10 of the present invention is connected to a plurality of PPP client terminals 20 (20-1 to 20-m) via access lines La (La-1 to La-m) and connected to layer 2 frame forwarding apparatuses (hereinafter referred to L2SWs) 30 (30-1, 30-2) via core lines (Lc-1, Lc-2). The L2SWs 30 are connected to the Internet NW including a DHCP server 50 for assigning IP addresses to the client terminals and a server 60 for providing diverse information services.

Although one DHCP server 50 and one server 60 are shown in FIG. 1 for simplification, a plurality of DHCP servers 50 corresponding to domains and a large number of servers 60 accessible from the client terminals may exist on the Internet NW.

The PPP gateway apparatus 10 is connected to each of L2SWs 30 through a layer 2 Ethernet link formed on a core line Lc, and Ethernet frames, each including an IP packet in the payload, are communicated between them. In this section of the network, a plurality of VLANs can be multiplexed on a same physical line by applying Virtual LAN (VLAN) according to IEEE 802.1Q. In this case, frame forwarding is controlled in accordance with a VLAN tag (VLAN ID) attached to the frame as a part of an Ethernet header.

Each L2SW 30 operates as an Ethernet switch and forwards Ethernet frames received from the PPP gateway apparatus 10 to the Internet NW after performing header conversion on the received frames. Upon receiving an Ethernet frame including an IP packet addressed to a client from the Internet NW, the L2SW 30 converts the header of the received frame and forwards it to the PPP gateway apparatus 10.

Each of the client terminals 20 accommodated to the PPP gateway apparatus 10 is provided with a PPP client communication function. Each client terminal 20 is connected to the PPP gateway apparatus 10 through a PPP link established on an access line La. In the present embodiment, it is assumed that the access lines La are Ethernet, and each client terminal 20 and the PPP gateway apparatus 10 communicate with each other, using Ethernet frames each having a PPPoE header and a PPP header.

The PPP gateway apparatus 10 is able to set up multiple PPP links on a same physical line by applying PPPoE. Although one client terminal 20 is connected to each physical line (access line) La in FIG. 1, a plurality of PPP client terminals 20 can be connected to the PPP gateway apparatus 10 via one access line La by setting up multiple logical PPP links on the same physical line.

The PPP gateway apparatus 10 decapsulates a frame received from a PPP link on each access line, converts the received frame into the Ethernet frame format adapted for communication with the L2SW, and forwards it to an appropriate core line Lc (Ethernet link) by means of a frame processor (Intelligent Switching function) which will be described later. Inversely, when an Ethernet frame is received from a core line Lc (Ethernet link), the gateway encapsulates an IP packet extracted from the received frame with a PPPoE header and a PPP header, converts it into the Ethernet frame adapted for communication with a client terminal, and forwards it to an appropriate PPP link.

The PPP gateway apparatus 10 is connected to a RADIUS server 40 that carries out user authentication and charging for a client terminal 20 having issued a PPP connection request. The PPP gateway apparatus 10 can obtain authorization information to be granted to the client terminal and an authentication result indicating whether a PPP connection with the client terminal is allowed to establish. However, it is not a necessary requirement for the PPP gateway apparatus 10 to connect to the RADIUS server 40. The PPP gateway apparatus 10 itself may maintain information required for client authentication. Although an IP address to be assigned to the client terminal 20 is available from the RADIUS server 40 during the user authentication procedure, the IP address is obtained from the DHCP server 50 in a commonly-used layer 2 network.

In the network architecture of FIG. 1, direct access from a client terminal 20 to the DHCP server 50 is impossible, because each client terminal 20 is connected to the PPP gateway apparatus 10 via PPP at layer 2. Thus, in the present embodiment, the PPP gateway apparatus 10 is provided with a DHCP client function so that the PPP gateway 10 accesses the DHCP server 50 via an Ethernet link at layer 2 on a core line instead of a client terminal 20 and gets an IP address to be assigned to the client terminal.

FIG. 2 shows protocol stacks on the client terminal 20, the PPP gateway apparatus (PPP GW) 10, the L2SW 30, and the server 60 in the network of FIG. 1.

The client terminal 20 establishes a PPP link between itself and the PPP gateway apparatus 10 to carry out IP communication between applications with the server 60 connected to the Internet NW. Because the PPP link is assumed to be established on an Ethernet access line La in the present embodiment, the protocol stack on the client terminal 20 includes Ethernet at the lowest layer, PPPoE and PPP positioned over Ethernet, and IP and application positioned as a upper stack over PPP.

Upon receiving an Ethernet frame from the client terminal 20, the PPP gateway apparatus 10 performs header processing on the headers from Ethernet to PPP. The PPP gateway apparatus 10 of the present invention includes only Ethernet in its protocol stack for communication with the L2SW 30. It operates as a gateway but with no IP in the protocol stack.

The L2SW 30 operates as an Ethernet switch and forwards a frame in the form of a Ethernet frame to the next node. The server 60 on the Internet NW is provided with an IP communication function and has a protocol stack including Ethernet at the lowest layer to carry out communication between applications with the client terminal 20.

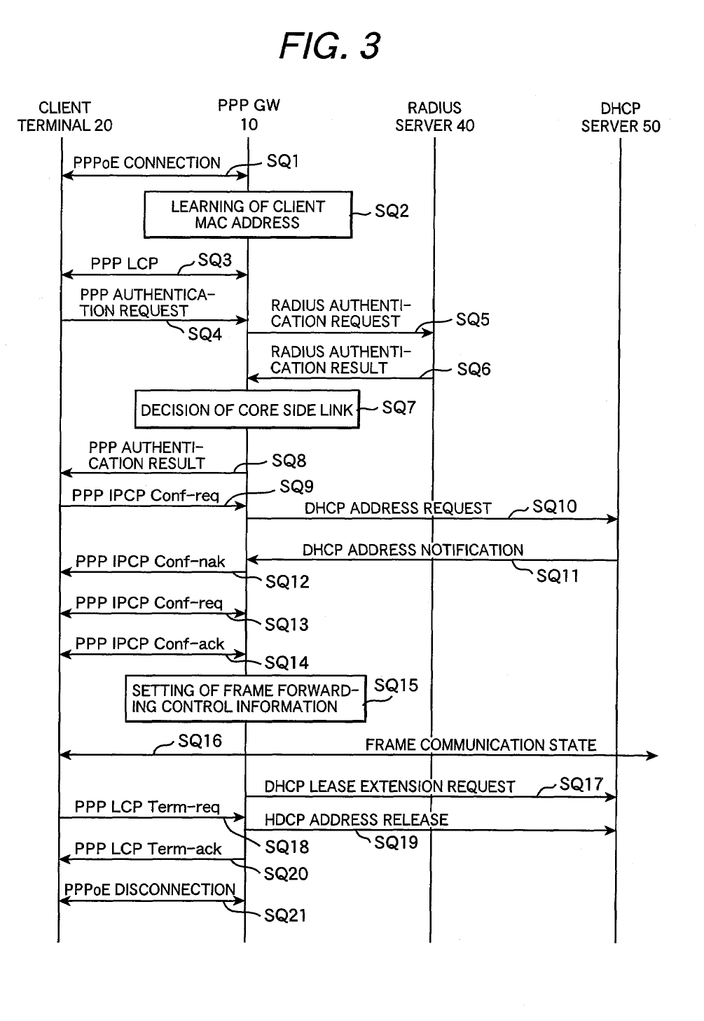

FIG. 3 illustrates a communication sequence for connecting the client terminal 20 to the Internet NW via the PPP gateway apparatus 10 of the present invention.

The client terminal 20 executes a connection procedure for a PPPoE session with the PPP gateway apparatus 10 in accordance with a commonly used PPPoE protocol (SQ1). Because the client terminal 20 applies its MAC address to the source MAC address of an Ethernet frame when executing the connection procedure for the PPPoE session, the PPP gateway apparatus 10 can learn the MAC address of the client terminal 20 during the connection procedure for the PPPoE session (SQ2).

When the PPPoE session has been established, the client 20 carries out negotiation of LCP (Link layer Control Protocol) in PPP with the PPP gateway apparatus 10 and establishes a PPP link (SQ3). After the PPP link has been established, the PPP gateway apparatus 10 performs connection authentication for the client terminal 20. In this illustrated example, an authentication request including user authentication information, such as a user identifier, password, etc., is transmitted from the client terminal 20 side to the PPP gateway apparatus 10 (SQ4).

Upon receiving the authentication request, the PPP gateway apparatus 10 transmits an authentication request (Access-Request) in accordance with a RADIUS protocol to the RADIUS server 40 (SQ5). This authentication request includes the user authentication information. Having received the authentication request from the PPP gateway apparatus 10, the RADIUS server 40 carries out user authentication by comparing the user authentication information specified in the authentication request with pre-registered user authentication information and returns an authentication result message to the PPP gateway apparatus 10 (SQ6).

In the case of successful user authentication, the RADIUS server 40 can notify the PPP gateway apparatus 10 of authorizations to be granted to the requester client terminal 2 by way of RADIUS attributes described in the authentication result message (“Access Accept”). An IP address to be used by the client 20 can also be notified by way of a Framed-IP-Address attribute in the message. In the present embodiment, an attribute for indicating a destination domain to which a frame received from the client should be forwarded is defined in the authentication result message (“Access Accept”) so that the PPP gateway apparatus 10 can forward frames received from the client terminal 20 to an appropriate L2SW 30 according to the destination domain.

Upon receiving the authentication result message of successful user authentication from RADIUS server 40, the PPP gateway apparatus determines a link on the core line side to be a forwarding destination of frames received from the requester client terminal 20 and registers a new table entry into a PPP user management table which will be described later (SQ7). After that, the PPP gateway apparatus 10 notifies the requester client terminal 20 of an authentication result, which is successful authentication in this illustrated example (SQ8). The user authentication procedure is completed by an event that the client terminal 20 receives the notification of successful authentication.

The client terminal 20 having succeeded in user authentication transmits a PPP IPCP Configuration Request to the PPP gateway apparatus 10 to establish an IP layer over the PPP link layer. Normally, a source device of the PPP IPCP Configuration Request indicates its IP address in the request to notifies a peer device of the IP address. In the present embodiment, however, the PPP gateway apparatus 10 assigns an IP address to the client terminal 20. Thus, triggered by the event of receiving the PPP IPCP Configuration Request, the PPP gateway apparatus 10 starts a procedure for getting an IP address to be assigned to the client terminal 20.

In the case where an IP address is assigned in the above-mentioned authentication result message (“Access Accept”) from the RADIUS server 40, the PPP gateway apparatus 10 may notify the requester client terminal 20 of the IP address specified in the received authentication result message by using PPP IPCP Configuration-nak (SQ12). In this illustrated example, it will be described in the case where an IP address is obtained from the DHCP server 50 operated in a layer 2 network, not from the RADIUS server 40.

The DHCP server 50 identifies an DHCP client based on a MAC address of the client terminal. Thus, the PPP gateway apparatus 10 sends an address request to the DHCP server 50 (SQ10). As a source MAC address of the address request, the MAC address of the client terminal 20 learned during the PPPoE connection is applied. The address request is transmitted from a link on the core line side (layer 2 Ethernet link) determined at SQ7. Upon obtaining the IP address of the client terminal 20 by an address notification from the DHCP server 50 (SQ11), the PPP gateway apparatus 10 notifies the requester client terminal 20 of this IP address by way of the PPP IPCP Configuration-nak (SQ12).

The client terminal 20 having notified of the IP address to be used by way of the PPP IPCP Configuration-nak transmits again a PPP IPCP Configuration Request to the PPP gateway apparatus 10. The PPP IPCP Configuration Request includes the above IP address as its source IP address. At this time, the PPP gateway apparatus 10 also transmits a PPP IPCP Configuration Request including an IP address of the gateway as its source IP address to the client terminal 20 (SQ13). The IPCP negotiation is completed by an event that both the PPP gateway apparatus 10 and the client terminal 20 send back acknowledge messages “PPP IPCP Configuration-ack” in response to the PPP IPCP Configuration Request messages received from the other (SQ14).

Upon the completion of the IPCP negotiation, the PPP gateway apparatus 10 determines a link on a core line Lc (layer 2 Ethernet link) to be used to forward frames received from the client terminal 20 and sets this link as forwarding control information into a frame forwarding control table (SQ15) in order to enable communication between the client terminal 20 and the Internet NW. Thereby, layer 2 frame communication (SQ16) according to the protocol stacks shown in FIG. 2 is enabled.

The DHCP server 50 is carrying out address management in which time to live is allocated for an IP address assigned to each user terminal and an IP address for which the time to live has expired is made invalid automatically. Therefore, a terminal assigned an IP address has to request an extension of an address lease period to the DHCP server 50 before the time to live of the address expires. In the present embodiment, since the PPP gateway apparatus 10 has requested address assignment to the DHCP server 50 instead of the client terminal 20, the PPP gateway apparatus 10 issues a request for IP address lease extension to the DHCP server 50 at predetermined intervals of time, as long as the PPP link with the client terminal 20 continues to exist (SQ17).

When terminating communication with the Internet NW, the client terminal 20 transmits a link disconnection request message (“PPP LCP Terminate Request”) to the PPP gateway apparatus 10 (SQ18). Upon receiving the PPP LCP Terminate Request, the PPP gateway apparatus 10 transmits a release request of the IP address assigned to the client terminal 20 to the DHCP server 50 (SQ19). After that, the PPP gateway apparatus 10 sends an acknowledge message (“PPP LCP Terminate-ack”) in reply to the link disconnection request to the client 20 (SQ20), and releases the PPP link. Subsequently, the PPP gateway apparatus 10 disconnects the PPPoE session (SQ21) and completes the communication with the client terminal 20.

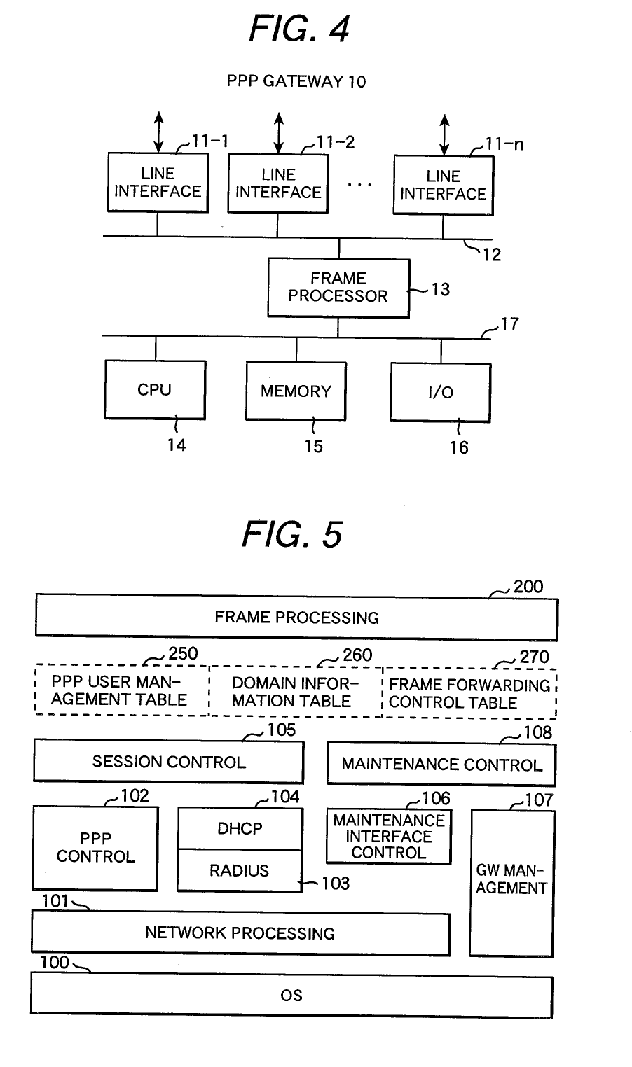

FIG. 4 shows an example of a hardware configuration of the PPP gateway apparatus 10.

The PPP gateway apparatus 10 is comprised of a plurality of line interfaces 11 (11-1 to 11-n), a frame processor 13 connected to these line interface by an internal bus 12, a CPU 14, a memory 15, and an I/O unit 16 connected to the frame processor 13 by an internal bus 17. In the memory 15, various software programs to be executed by the frame processor 13 and the CPU 14 are stored and data tables necessary in the frame forwarding control are created, as will be described later by referring to FIG. 5.

Each of the line interfaces 11 (11-1 to 11-n) is connected to one of the access lines La (La-1 to La-m), core lines Lc (Lc-1, Lc-2), and a connection line for the RADIUS server 40, shown in FIG. 1. Communication frames received by the line interfaces 11 from these physical lines are read into the frame processor 13 via the internal bus 12.

The frame processor 13 judges the type of a received frame and passes the frame to the CPU 14 when the frame is one of control messages of PPPoE, PPP, and DHCP having described by referring to FIG. 3. If the received frame is a user packet frame to be forwarded to one of client terminals 20 and L2SWs 30, that is, a user packet frame that meets a condition for forwarding between a PPP link and a layer 2 Ethernet link, the frame processor 13 performs header conversion on the received frame according to the switching condition, which has been pre-defined in a frame forwarding control table by the CPU 14, and transmits the frame to a physical line through an appropriate line interface 11. A control message of PPPoE, PPP, or DHCP generated by the CPU 14 is output to a predetermined line interface 11 via the frame processor 13.

FIG. 5 shows an example of a software configuration of the PPP gateway apparatus 10. This figure shows a general organization of software (programs) to be executed by the CPU 14 and software to be executed by the frame processor 13. Along with the programs, data tables managed by the CPU 14, a part of which are referred to by the frame processor 13, are shown, surrounded by dotted lines.

Over the OS 100 to be executed by the CPU 14, there exists a network processing routine 101 for controlling communication with the frame processor 13. Over the network processing routine 101, various protocol applications are prepared. In this illustrated example, as the protocol applications, a PPP control module 102 for executing communication procedure in accordance with the PPP protocol, a RADIUS (client) module 103 for communication with the RADIUS server 40, a DHCP (client) module 104 for communication with the DHCP server 50, and a maintenance interface module 106 are shown. The maintenance interface module 106 supports a command line interface for use in the I/O unit 16 or a maintenance communication such as SNMP.

Cooperation of these protocol modules is controlled by a session control module 105. The session control module 105 manages the table entries of the PPP user management table 250 for managing connection status of the client terminals 20, domain information table 260, and frame forwarding control table 270.

The frame processing routine 200 is executed by the frame processor 13. The frame processing routine 200 carries out frame conversion between a communication frame for a PPP link on an access line and a communication frame for a layer 2 Ethernet link on a core line, according to the switching conditions (frame forwarding control information) defined in the frame forwarding control table 270, as will be described later.

Over the maintenance interface module 106, a maintenance control module 108 is prepared for setting maintenance related parameters for the maintenance interface module 106, a GW management module 107, and other function units, and for collecting maintenance information from these modules. The maintenance control module 108 performs control operation such as notification of events occurred in the PPP gateway apparatus 10 to an external management system.

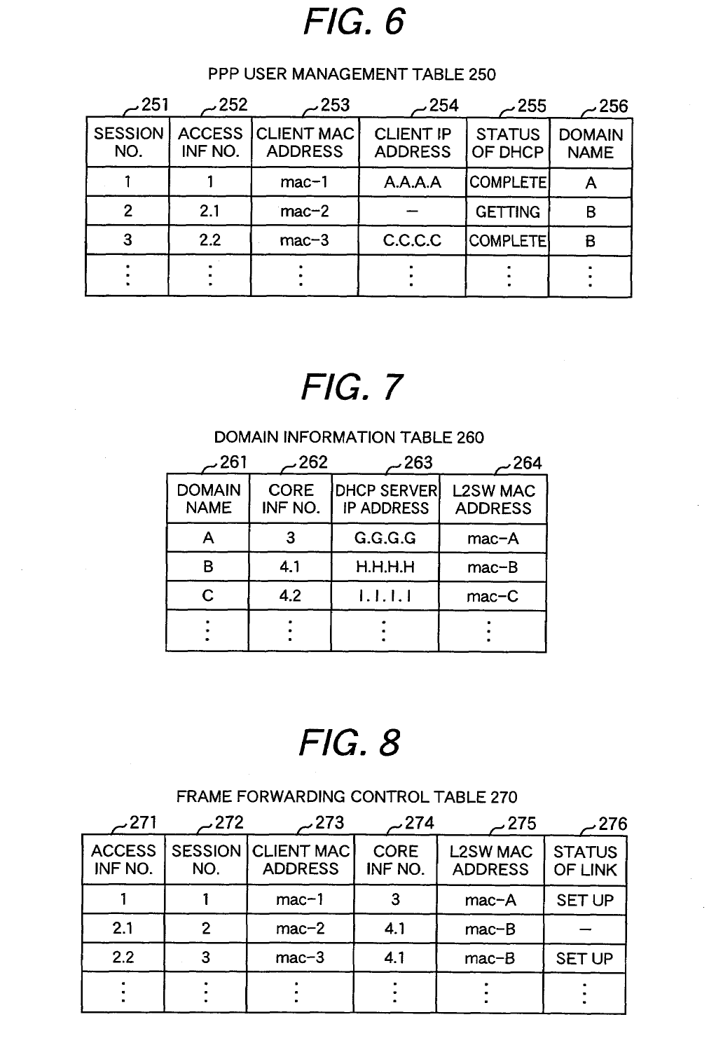

FIG. 6 illustrates the PPP user management table 250 to be used for managing the connection status of the client terminals 20.

The PPP user management table 250 is comprised of a plurality of table entries corresponding to the PPP links established on the access lines La. Each table entry includes a session number 251, an access interface (INF) number 252, a client MAC address 253, a client IP address 254, status of DHCP 255, and a domain name 256.

The session number 251 indicates a PPP link established on the access link La and it may be a PPPoE session number, if PPPoE is used. Unique session numbers are assigned to the PPP links so that all links connected to the PPP gateway apparatus 10 can be identified.

The access INF number 252 indicates an interface number assigned to each interface that accommodates a PPP link. The access INF number 252 is hierarchically expressed as “a physical link number+a logical link number”. Here, the physical link number means the number of an access line La on which the PPP link is formed. Each of line interfaces 12 is identified by the physical link number. The logical link number means the identification number of a layer 2 link multiplexed on the access line La and indicates a VLAN tag number in the case of Ethernet.

For example, an access INF number “2.1” in the second table entry shown in FIG. 6 means that a PPP link having the session number “2” is connected to a line interface having the physical link number “2” by a logical link having the logical link number “1”. However, if only one PPP link is formed on each access line, the logical link number is not necessary.

The client MAC address 253 indicates the MAC address of the client terminal 20 which was learned in the step SQ2 of the PPPoE procedure. The client terminal 20 transmits a packet to the L2SW 30 in the form of an Ethernet frame in which this MAC address 253 is used as the source MAC address. The client IP address 254 indicates the IP address assigned to the client terminal 20. The status of DHCP 255 indicates the status of IP address acquisition from the DHCP server 50 for the PPP link. The domain name 256 indicates identification information of a domain to which the client terminal 20 belongs. The domain name 256 is notified by the authentication result message (SQ6) from the RADIUS server 40.

FIG. 7 illustrates the domain information table 260.

The domain information table 260 is comprised of a plurality of table entries, each including domain name 261, core interface (INF) number 262, DHCP server IP address 263, and L2SW MAC address 264. The frame processor 13 of the PPP gateway apparatus 10 can determine the layer 2 Ethernet link on a core line, the DHCP server, and the L2SW to which a PPP link should be connect, by referring to the domain information table 260.

The domain name 261 corresponds to the domain name 256 registered in the PPP user management table 250. The core INF number 262 indicates the number of an interface connected to a core line Lc corresponding to the domain name 261, which is hierarchically expressed as “a physical link number+a logical link number”.

The DHCP server IP address 263 indicates the IP address of a DHCP server 50 belonging to each domain. In the second table entry with “B” as the domain name 261 of the table shown in FIG. 7, for example, the core INF number 262 is “4.1”, the DHCP server IP address 263 is “H.H.H.H”, and the L2SW MAC address 264 is “mac-B”. This entry means that a PPP link (client terminal) having a value “2” as the session number 251 in the PPP user management table 250 shown in FIG. 6 is connected to a L2SW having the MAC address “mac-B” via an Ethernet link having the physical link number “4” and the logical link number “1” formed on a core line Lc and that the client terminal is assigned with an IP address from a DHCP server 50 having the IP address “H.H.H.H”.

Referring to the PPP user management table 250 shown in FIG. 6, also in the third table entry with a value “3” as the session number 251, the domain name 256 is “B”. Therefore, on the Ethernet link having the physical link number “4” and the logical link number “1”, communication frames received from two PPP links having session numbers “2” and “3” on the access line side are transmitted by multiplexing.

FIG. 8 illustrates the frame forwarding control table 270.

The frame forwarding control table 270 defines the switching conditions for the Ethernet frame forwarding to be executed by the frame processor 13. This table is comprised of a plurality of table entries each relating a PPP link on the access line La side to a layer 2 Ethernet link on the core line Lc side. The frame forwarding control table 270 is created by the CPU 14 (session control module 105) based on the PPP user management table 250 and the domain information table 260.

Each table entry of the frame forwarding control table 270 indicates the correspondence of the access INF number 271 and session number 272 of a PPP link, which is established on an access line La side, to client MAC address 273, core INF number 274, L2SW MAC address 275, and status of link 276.

The access INF number 271, session number 272, and client MAC address 273 are the same as the access INF number 252, session number 251, and client MAC address 253 in the PPP user management table 250. The core INF number 274 is the same as the core INF number 262 in the domain information table 260. The status of link 276 indicates whether the PPP link has been established. The switching condition defined in each table entry becomes valid when the status of link 276 indicates that the PPP link has been set up. If the status of link 276 indicates that the PPP link has not yet established, for example, as shown in the table entry having the session number “2”, the switching condition defined in the entry is invalid and does not apply to frame forwarding control.

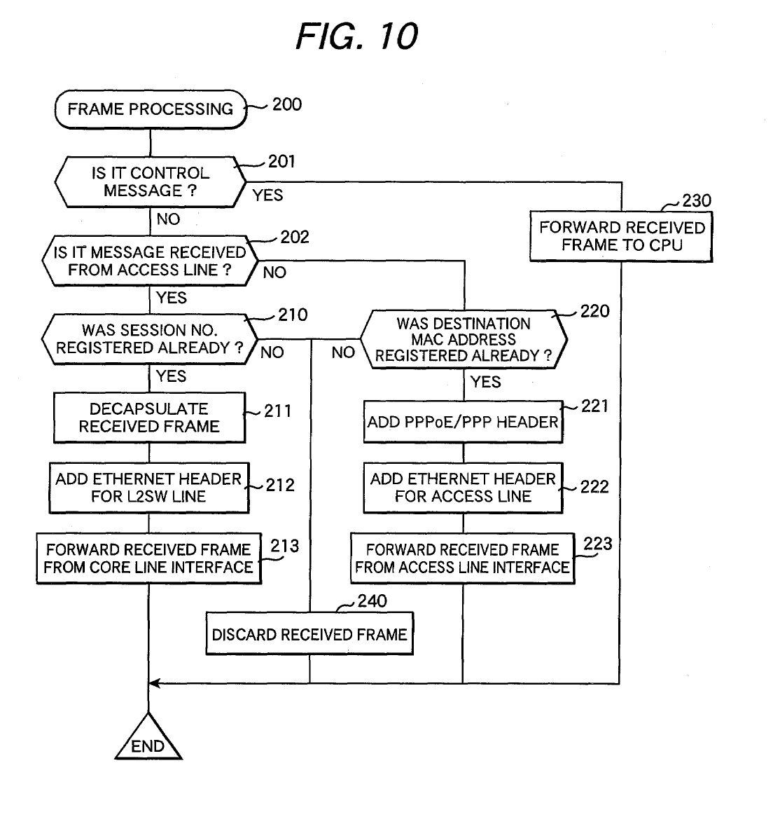

The frame processor 13 executes the frame processing routine 200 as will be detailed with FIG. 10 and performs header conversion and forwarding control on communication frames received from each of access lines La and core lines Lc, according to the switching conditions specified in the frame forwarding control table 270.

For example, assume that the PPP gateway apparatus 10 has received a PPP frame having the session number “3” through a line interface 11-2 identified by the access INF number “2.2”. In this case, the frame processor 13 searches the frame forwarding control table 270 for the third table entry corresponding to the above session number. After eliminating the PPPoE header and the PPP header from the received frame, the frame processor 13 converts the destination MAC address in the Ethernet header of the received frame into the MAC address “mac-B” of the L2SW and sets the value “1” of logical link number indicated by the core INF number 274 to the VLAN tag, according to the definition specified in the above entry. This frame is transmitted through a core line interface 11-4 specified by the physical link number “4” of the core INF number 274.

For example, if an Ethernet frame with the destination MAC address “mac-1” has been received through a line interface 11-3 corresponding to the core INF number “3”, the frame processor 13 searches the frame forwarding control table 270 for the first table entry having the client MAC address 273 matched with the destination MAC address “mac-1”, converts the received frame into a PPP frame according the definition specified in the table entry. In this case, the PPPoE header and the PPP header having the session number “1” are inserted between the Ethernet header and the IP packet and the source MAC address in the Ethernet header is replaced by the MAC address of the PPP gateway apparatus 10. The PPP frame is transmitted to the client terminal 20 through a line interface 11-1 having the access IF number “1”.

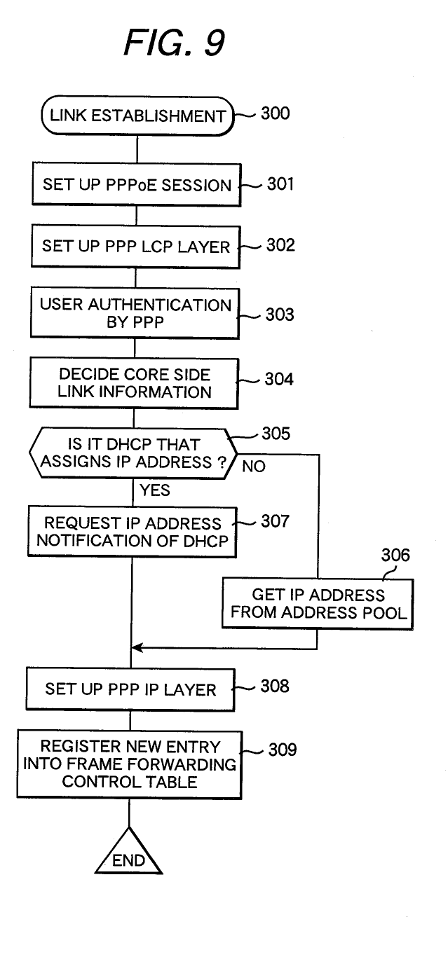

FIG. 9 shows a flowchart for establishing a link, which is performed by the CPU 14 of the PPP gateway apparatus 10.

In response to a request from a client terminal 20, the CPU 14 of the PPP gateway apparatus 10 executes a procedure of setting up a PPPoE session with the client terminal 20 (301). At this time, the MAC address of the client terminal is learned. After that, the CPU 14 carries out PPP LCP negotiation with the client terminal 20 and sets up an LCP layer (302). Then, the CPU 14 executes a procedure for user authentication by PPP (303). The user authentication may be implemented by using authentication information for each client stored in the PPP gateway apparatus 10 or by communicating with the RADIUS server 40.

Through the user authentication, core line link information such as the domain name to which the client terminal 20 belongs, the MAC address of the L2SW, and the DHCP server address is specified (304). The CPU 14 judges the method of assigning an IP address to the client terminal 20 (305). If the IP address should be obtained from the DHCP server 50, the CPU 14 requests the DHCP server 50 specified by the user authentication to notify an IP address (307). If no DHCP server 50 is used, the CPU 14 gets an unused IP address from an IP address pool prepared in the PPP gateway apparatus 10 (306).

When the IP address to be assigned to the client terminal has been determined, the CPU 14 carries out IPCP negotiation in PPP with the client terminal 20 and sets up an IP layer (308). After that, the CPU 14 registers new table entries to the above-described PPP user management table 250, domain information table 260, and frame forwarding control table 270, whereby communication frame forwarding is enabled between the client terminal and the L2SW 30.

FIG. 10 shows a flowchart of the frame processing routine 200 to be performed by the frame processor 13 of the PPP gateway apparatus 10.

The frame processor 13 accesses the line interfaces 11 (11-1 to 11-n) circularly and processes a communication frame received from each line interface in accordance with the frame processing routine 200.

The frame processor 13 judges whether the received frame includes a control message in PPPoE, PPP, or the like mentioned in FIG. 3 (201) from the message type of the received frame. If the received frame includes a control message, the frame processor transfers it to the CPU 14 (230) and terminates this routine. If the received frame is not for a control message, the frame processor 13 judges whether the received frame has been received from an access line La or received from a core line (202) by referring to, for example, a line management table for indicating the correspondence of each line interface number to the type of the line connected to the interface.

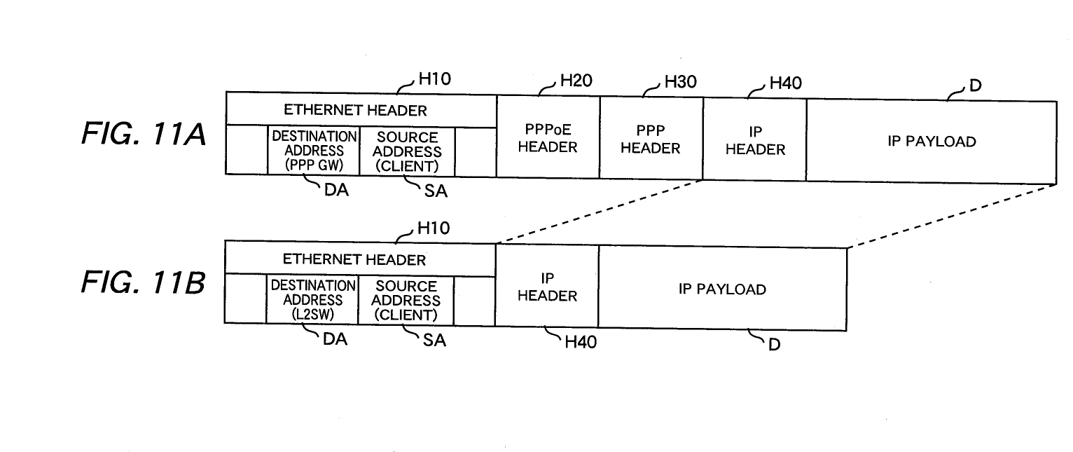

If the received frame is one received from an access line La-j, the received frame is comprised of the Ethernet header H10, PPPoE header H20, PPP header H30, IP header H40, and IP payload D, and includes a destination MAC address DA, a source MAC address SA and other information in the Ethernet header H10 as illustrated in FIG. 11A. The destination MAC address DA includes the MAC address of the PPP gateway apparatus 10 and the source MAC address SA includes the MAC address of the client terminal 20.

In this case, the frame processor 13 extracts the session number from the PPPoE header H20 of the received frame and searches the frame forwarding control table 270 for a table entry having the same session number as that of the received message and judges whether the session has already been established or not based on the status of link 276 (210).

If the table entry having the same session number as that of the received message is not registered in the frame forwarding control table 270, or if the status of link 276 in the searched table entry indicates that the session has not been established yet, the frame processor 13 discards the received frame (240) and terminates this routine.

If a valid table entry having the same session number as that of the received message has been found from the frame forwarding control table 270, the frame processor 13 eliminates the Ethernet header H10, PPPoE header H20, and PPP header H30 from the received frame (211), creates a new Ethernet header in accordance with the contents of the table entry searched from the frame forwarding control table and generates a frame for layer 2 Ethernet link to be transmitted from a core line interface (212).

A frame for layer 2 Ethernet link is comprised of an IP packet part (IP header H40 and IP payload D) extracted from the received frame and a new Ethernet header H10, for example, as illustrated in FIG. 11B. The Ethernet header H10 includes the MAC address of the L2SW as its destination MAC address DA, the MAC address of the client terminal 20 as its source MAC address SA, and the logical link number on the core line as its VLAN tag. Here, the L2SW MAC address 275 of the searched table entry is applied to the MAC address of the L2SW and the logical link number indicated by the core INF number 274 of the table entry is applied to the VLAN tag.

The frame processor 13 transfers the above frame to the line interface 11-k corresponding to the physical link number k indicated by the core INF number 247 of the table entry (213) and terminates this routine.

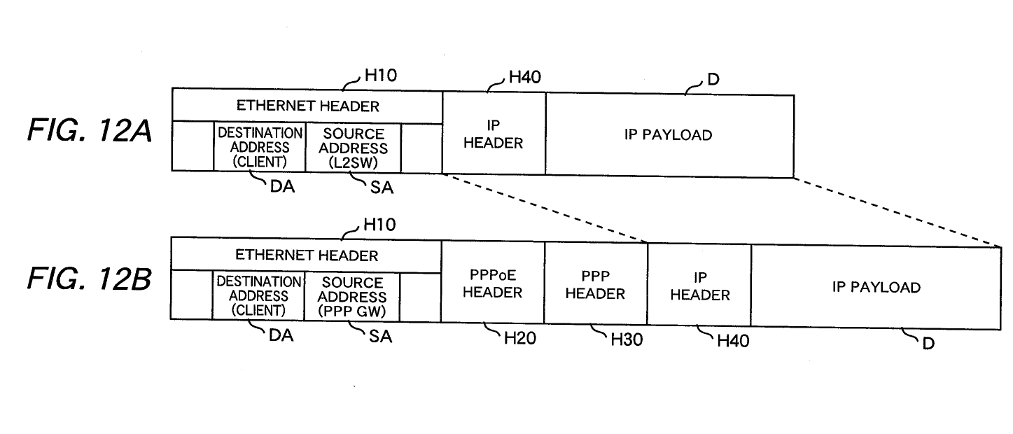

If it is judged that the frame is received from a core line Lc-j at step 202, the received frame is comprised of the Ethernet header H10, IP header H40, and IP payload D, as illustrated in FIG. 12A. In particular, the destination MAC address DA in the Ethernet header H10 specifies the MAC address of the client terminal 20, the source MAC address SA specifies the MAC address of the L2SW, and the VLAN tag specifies the logical link number on the core line.

In this case, the frame processor 13 searches the frame forwarding control table 270 for a table entry having the client MAC address 273 matched with the destination MAC address DA of the received frame and specifies the values of the access INF number 271 and the session number 272.

In a communication network applying L2SWs, flooding is usually performed when a learned MAC address cannot be found out from a management table. According to the present embodiment, however, the PPP gateway apparatus 10 operates on the assumption that, for any client terminal which is connected to the L2SW, its MAC address has been already registered in the frame forwarding control table 270. Thus, if a table entry including the same MAC address as the destination MAC address DA of the received message is not registered in the frame forwarding control table 270, the frame processor 13 discards the received frame (240) and terminates this routine.

If the table entry including the same MAC address as the destination MAC address is found out from the frame forwarding control table 270, the frame processor 13 generates a PPPoE header H20 and a PPP header H30 in which the session number 272 specified in that table entry is applied and adds these headers to the IP packet extracted from the received frame (221). The frame processor 13 further creates a new Ethernet header including the MAC address of the client terminal 20 as its destination MAC address and the MAC address of the PPP gateway apparatus 10 as its source MAC address. The frame processor 13 adds this Ethernet header to the PPPoE packet, thereby to generate a frame for PPP link as illustrated in FIG. 12B (222). The frame processor 13 transmits the frame through the line interface corresponding to the physical link number indicated by the access INF number 271 in the above table entry (223) and terminates this routine.

According to the embodiment described above, during a process of establishing a PPP link with a client terminal, the PPP gateway apparatus 10 is able to automatically set a new switching condition corresponding to the session number of the PPP link in the frame forwarding control table. By referring to this frame forwarding control table, the gateway can make mutual conversion between PPP frames on an access line side and layer 2 Ethernet frames on a core line side and connect a PPP client terminal to a layer 2 Ethernet link.

What is claimed is:

1. A PPP gateway apparatus for connecting a plurality of PPP (Point to Point Protocol) client terminals to one of layer 2 frame forwarding apparatuses, comprising:
a plurality of line interfaces each accommodating one of access lines for connecting to the client terminals and core lines for connecting to the layer 2 frame forwarding apparatuses;
a frame forwarding control table comprising a plurality of table entries each indicating the correspondence of a PPP session number to a client MAC address and frame definition information for one of said core lines;
a frame processor for controlling communication frame forwarding between each of said client terminals and said layer 2 frame forwarding apparatuses,
wherein said frame processor operates, based on said frame forwarding control table, to forward a PPP frame received from each of said access lines to one of said core lines after converting it into a layer 2 Ethernet frame and to forward a frame received from one of said core lines and destined for a particular client MAC address to one of said access lines after converting it into a PPP frame.

2. The PPP gateway apparatus according to claim 1, wherein:
each entry of said frame forwarding control table includes an access line interface number; and
said frame processor operates, when processing a frame received from one of said core lines, to search said frame forwarding control table for a table entry including a client MAC address matched with the destination MAC address of the received frame, convert the received frame into a PPP frame in accordance with the session number indicated in the table entry, and transmit the PPP frame through one of said line interfaces specified by the access line interface number indicated in the table entry.

3. The PPP gateway apparatus according to claim 1, wherein:
each table entry of said frame forwarding control table includes a core line interface number and a MAC address of one of said frame forwarding apparatuses as said frame definition information for the core line; and
said frame processor operates, when processing a frame received from one of said access lines, to search said frame forwarding control table for a table entry including a session number matched with a PPP session number extracted from the received frame, convert the received frame into a layer 2 Ethernet frame destined for the frame forwarding apparatus MAC address indicated in the searched table entry, and transmit the Ethernet frame through one of said line interfaces specified by the core line interface number indicated in the searched table entry.

4. The PPP gateway apparatus according to claim 3, wherein:
said core line interface number is comprised of a physical link number and a logical link number; and
said frame processor transmits, as said layer 2 Ethernet frame, a frame including the logical link number as identification information to one of said core lines specified by the physical link number.

5. The PPP gateway apparatus according to claim 1, wherein:
each of said PPP frames to be communicated through the line interface accommodating one of said access lines comprises an Ethernet header, a PPPoE header, a PPP header, and an IP packet; and
each of said layer 2 Ethernet frames to be communicated through the line interface accommodating one of said core lines comprises an Ethernet header and an IP packet.

6. The PPP gateway apparatus according to claim 1, further comprising:
a session control unit for executing a communication procedure for PPPoE and PPP between the gateway and each of said client terminals,
wherein said session control unit specifies a MAC address of the client terminal and a PPP session number during the execution of a PPPoE connection procedure, specifies the frame definition information for one of said core lines during the execution of a client authentication procedure which is performed after PPP link establishment, and adds a new table entry corresponding to the specified PPP session number to said frame forwarding control table.

7. The PPP gateway apparatus according to claim 6, further comprising:
a domain information table comprising a plurality of table entries each defining the correspondence of a domain name to a core line interface number and the MAC address of one of said frame forwarding apparatuses,
wherein said session control unit specifies the core line interface number and the MAC address of said frame forwarding apparatus by referring to said domain information table based on the domain name, which is notified from an authentication server and to which the client terminal belongs, during the execution of said client authentication procedure, and adds a new entry including the core line interface number and the MAC address of the frame forwarding apparatus as the frame definition information for the core line to said frame forwarding control table.

8. The PPP gateway apparatus according to claim 7, wherein:
each entry of said domain information table includes an IP address of a DHCP server corresponding to the domain name; and
said session control unit obtains the IP address to be assigned to each client terminal from a DHCP server specified in said domain information table.
